(19) United States
(12) Patent Application Publication
(10) Pub. No.: US 2010/0084221 A1
(43) Pub. Date: Apr. 8, 2010

(54) Sawhorse accessory

(76) Inventor: Dina M. Cuccio, Lake Charles, IA (US)

Correspondence Address: LITMAN LAW OFFICES, LTD., POST OFFICE BOX 41200, SOUTH STATION, ARLINGTON, VA, 22204, US

(21) Appl. No.: 12/285,562

(22) Filed: Oct. 8, 2008

(51) Int. Cl. F16M 11/00

(52) U.S. Cl. 182/129

(57) ABSTRACT

The sawhorse accessory includes a an elongate attachment for removable installation atop a sawhorse rail. Each attachment includes a plurality of transverse V-shaped notches therein, with the notches each having a ninety degree included angle. Two sawhorses, each having one of the accessories attached thereto, are placed parallel to one another, with the notched accessories providing for the secure placement of elongate workpieces (corner molding, etc.) thereacross. Each of the workpieces has a right angle edge that fits securely within the notches of the sawhorse accessories. The sawhorse accessories hold the workpieces securely for sanding, painting, varnishing, staining, and the like, precluding turning of the workpieces due to pressure from a paintbrush or other tool during the work. The workpiece supports may be attached to the sawhorses by clamps, elastic bungee cords, or by bolting to the sawhorse rail.

### BACKGROUND OF THE INVENTION

1. Field of the Invention

The present invention relates generally to building and construction tools, and more particularly to a sawhorse accessory that provides an attachment for use upon a sawhorse for holding lengths of material with right angle edges, such as corner molding and the like, for work thereon.

2. Description of the Related Art

The general concept of the sawhorse or sawbuck has been known for a considerable time. Over the years a number of modifications and improvements have been made to the basic sawhorse configuration, e.g., folding, adjustment, different materials, storage compartments or pockets, etc. Many such improvements have been intended to create a more specialized sawhorse or sawbuck fixture for special purposes or operations. Most of these various changes have been beneficial to some degree or another, depending upon the needs of the user of the device.

An example of such is shown in German Patent No. 20 2006 003 712, published on Jul. 19, 2007. Although no English abstract is available, this reference-appears from the drawings to describe a sawbuck comprising a series of three X-configuration member pairs with the two crossmembers of each pair joined by a pivot or hinge bolt that can be locked to lock the angle between the crossmembers as desired. Lower longitudinal bracing is used to connect the X-configuration member pairs.

Nevertheless, there remains a need for a sawhorse that can support molding and similar pieces during cutting operations. Thus, a sawhorse accessory solving the aforementioned problems is desired.

### SUMMARY OF THE INVENTION

The sawhorse accessory includes various embodiments of an elongate component that attaches to the top of the sawhorse rail. The accessory includes a series of transverse notches, with each of the notches having an included angle of as close to ninety degrees as practicable. One such accessory may be removably attached to a corresponding one of a pair of sawhorses, and the sawhorses spaced apart with their rails parallel to one another. One or more elongate workpieces having right angle edges (e.g., corner moldings, etc.) may then be placed across the sawhorses in the notches for work thereon, with the right angle edges of the workpieces resting securely within the mating notches of the sawhorse attachments. The notches hold the workpieces securely and prevent the workpieces from moving laterally under the pressure of a paintbrush or other tool, while simultaneously preventing the workpieces from rolling or turning during such work.

The sawhorse accessories may be provided with a number of different sawhorse attachment means. Clamps may be provided extending from the sides of the accessories, and securing about the sides and underside of the sawhorse rail. Elastic cords (bungees) may be extended beneath the rail to secure to brackets on each side of the accessory. Alternatively, one or more bolts may be installed through corresponding holes in the accessory and underlying sawhorse rail to secure the accessory thereto.

These and other features of the present invention will become readily apparent upon further review of the following specification and drawings.

### BRIEF DESCRIPTION OF THE DRAWINGS

FIG. 1 is an environmental, perspective view of a pair of sawhorses each having a first embodiment of a sawhorse accessory according to the present invention installed thereon and holding a series of workpieces.

FIG. 2 is an exploded perspective view of a second embodiment of a sawhorse accessory according to the present invention for bolting to an existing sawhorse having a channel or receptacle formed in the rail thereof.

FIG. 3 is a perspective view of a third embodiment sawhorse accessory according to the present invention mounted atop the rail of a sawhorse using elastic bungee cords.

Similar reference characters denote corresponding features consistently throughout the attached drawings.

### DETAILED DESCRIPTION OF THE PREFERRED EMBODIMENTS

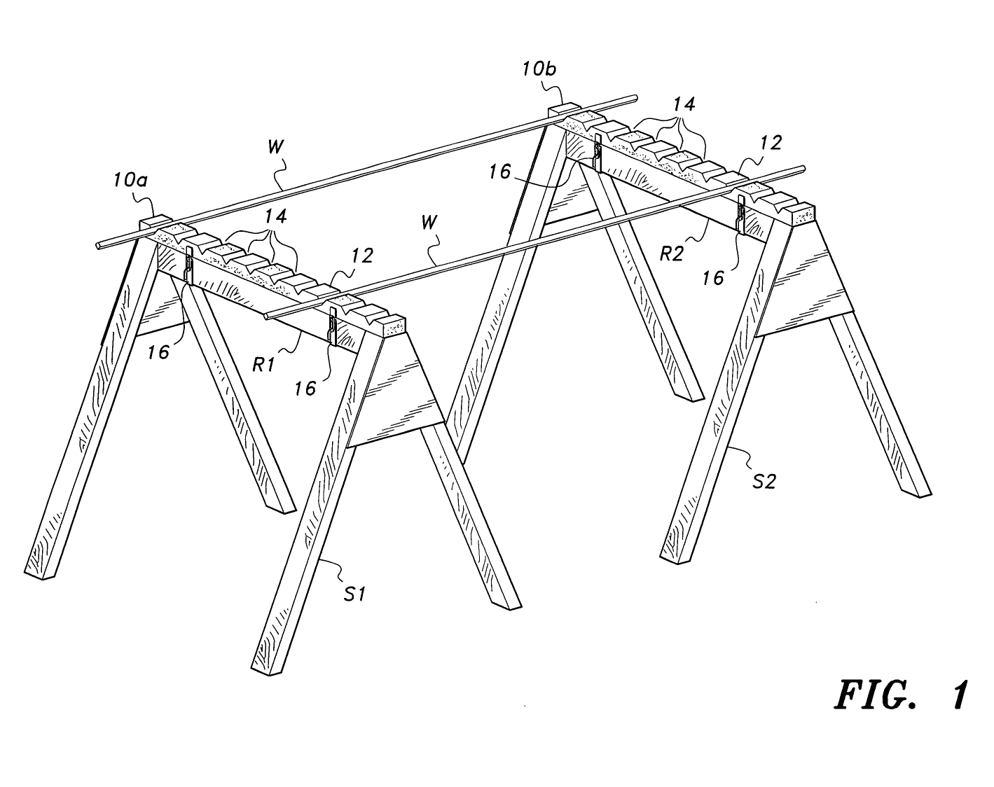

The present invention is a sawhorse accessory that provides for secure placement of one or more elongate workpieces thereon and precludes undesired movement of the workpieces during work thereon. FIG. 1 provides an environmental perspective view of a pair of the sawhorse accessories 10a and 10b secured in place upon the corresponding upper rails R1 and R2 of a pair of sawhorses S1 and S2. Each of the sawhorse accessories comprises an elongate workpiece support adapted for removably attaching to the upper rail of a sawhorse. Each sawhorse accessory or workpiece support 10a and 10b has an upper surface 12 with a series of transverse workpiece holding notches 14 therein, with each of the notches having an included angle as close as practicable to ninety degrees. When two such workpiece supports 10a and 10b are secured to the upper rails R1 and R2 of a pair of sawhorses S1 and S2 and spaced apart substantially parallel to one another, a number of elongate workpieces W having right angle edges (corner moldings such as quarter round lengths, etc.) may be placed and held securely within the notches 12, with the notches preventing the workpieces W from moving or rolling during light sanding, painting, staining, or other work thereon.

The sawhorse accessories or workpiece supports 10a, 10b of FIG. 1 are secured to the respective sawhorses S1 and 52 by a series of attachment fixtures comprising over-center toggle actuated latches 16. These latches 16 are permanently secured to the two sides of each workpiece support 10a and 10b, and have clamps extending downwardly therefrom that catch or hook beneath the bottom of the respective sawhorse rail when closed or latched.

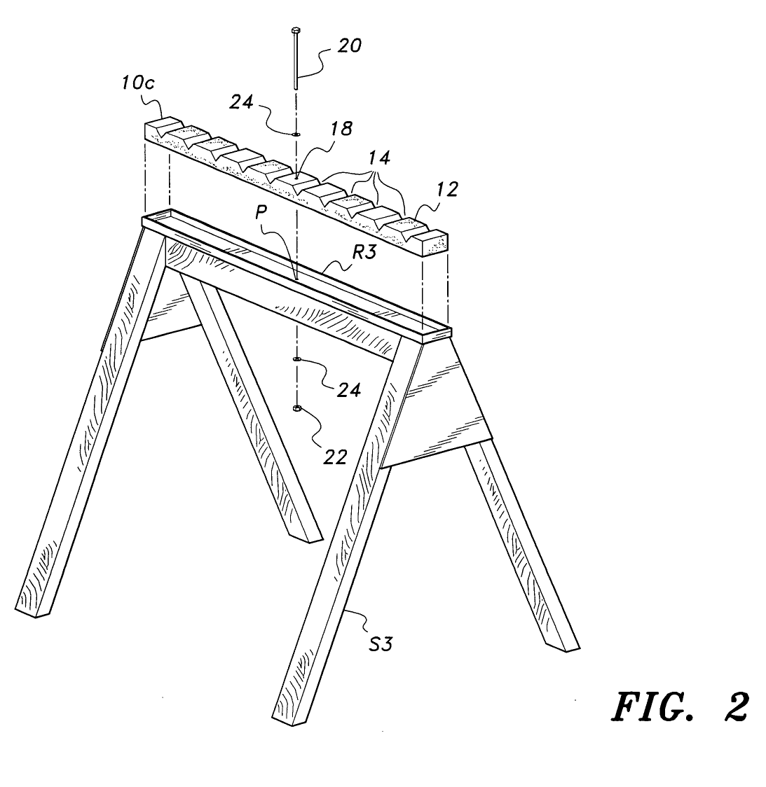

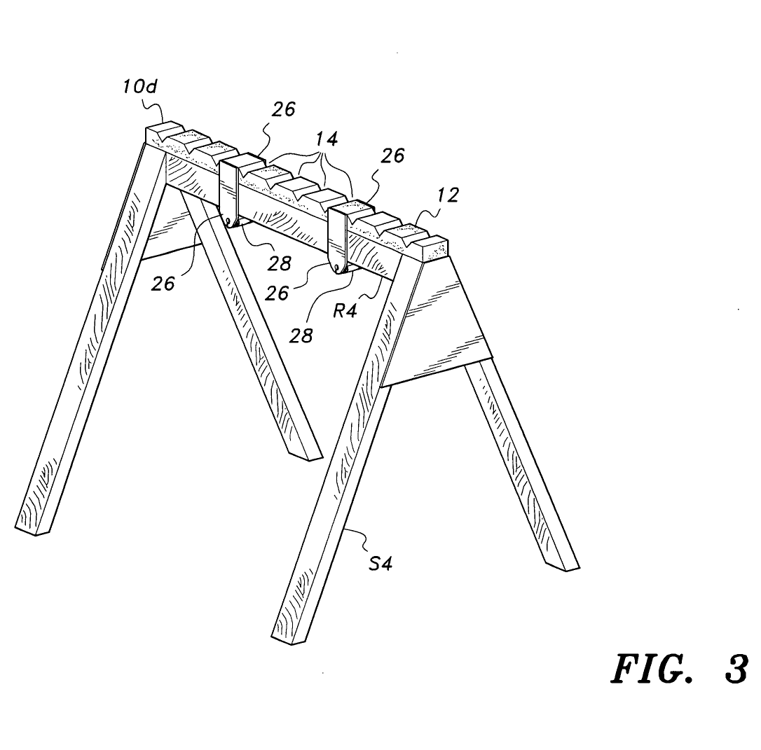

FIG. 2 is an exploded perspective view of an alternative sawhorse configuration S3. The sawhorse S3 includes a rail R3 having upwardly extending sides defining a tray or recess in the center of the rail. Such sawhorses are manufactured commercially by the Stanley Corporation. The rail R3 includes a fastener hole or passage P therethrough, providing for the bolted attachment of an article thereto. Accordingly, the sawhorse accessory or workpiece support 10c with its upper surface notches 14 includes a fastener hole or passage 18 therethrough, aligned with the hole or passage P of the sawhorse rail R3 when the workpiece support 10c is installed within the tray of the rail R3. A single bolt 20, nut 22, and washers 24 are used in the exemplary assembly of FIG. 2, as the sawhorse accessory or workpiece support 10c cannot pivot atop the sawhorse rail R3 due to the upwardly extending sidewalls or flanges that cradle the workpiece support 10c therein. Alternatively, two or more nut, bolt, and washer assemblies may be used to secure the workpiece support 10c to the rail R3 of the sawhorse S3, when corresponding holes or passages are provided. It will also be seen that either or both of the sawhorses S1 and S2 of FIG. 1 may have drilled rails, allowing the workpiece attachment 10c of FIG. 3 to be used with the sawhorses S1 and S2 of FIG. 1 if so desired.

FIG. 3 shows a sawhorse and workpiece support assembly having another type of attachment than those shown in FIGS. 1 and 2 and described above. The workpiece support 10d of FIG. 3 with its upper surface notches 14 includes a series of brackets 26 or the like extending downwardly therefrom and having sufficient length to extend below the rail R4 of the sawhorse S4 when the workpiece support 10d is placed thereon. A corresponding number of elastic bungee cords 28, i.e., one cord extending between each opposed bracket 26 of a pair, are extended across the underside of the sawhorse rail R4 to secure the workpiece support 10d to the rail R4.

In conclusion, the sawhorse accessory in its various embodiments greatly facilitates the task of working with elongate trim pieces such as quarter round moldings, triangular cross section pieces (chamfers), and other such workpieces having right angle edges. It will be seen that at least two of the embodiments, i.e., the workpiece supports 10a and 10b of FIG. 1 and the workpiece support 10d of FIG. 3, are interchangeable with one another for use with conventional sawhorses. The workpiece support 10c of FIG. 2 may be readily used with a conventional sawhorse merely by modifying the sawhorse with a hole or passage through the rail thereof for attachment of the workpiece support 10c. Any of the above combinations of installations eliminates the problem of elongate moldings and similar trim pieces rolling or moving during painting, varnishing, staining, light sanding, and similar work, thus greatly facilitating the task at hand for the craftsman.

It is to be understood that the present invention is not limited to the embodiments described above, but encompasses any and all embodiments within the scope of the following claims.

I claim:

1. A sawhorse accessory, comprising:
an elongate workpiece support adapted for removable installation atop a rail of a sawhorse, the workpiece support having an upper surface having a plurality of transverse workpiece-holding notches defined therein, each of the notches forming a ninety degree included angle; and
means for attaching the workpiece support atop the sawhorse rail.

2. The sawhorse accessory according to claim 1, further including at least one sawhorse having an upper rail, the workpiece support being attached to the sawhorse upper rail.

3. The sawhorse accessory according to claim 1, wherein the means for attaching comprises an over-center latch.

4. The sawhorse accessory according to claim 1, wherein the means for attaching comprises a bolt and mating nut.

5. The sawhorse accessory according to claim 1, wherein the means for attaching comprises an elastic cord.

6. A sawhorse accessory, comprising:
at least one sawhorse having an upper rail;
an elongate workpiece support removably disposed atop the upper rail of the sawhorse, the workpiece support having an upper surface having a plurality of transverse workpiece-holding notches defined therein, each of the notches forming a ninety degree included angle; and
means for attaching the workpiece support atop the sawhorse rail.

7. The sawhorse accessory according to claim 6, wherein said at least one sawhorse comprises first and second sawhorses, each of the sawhorses having one of the elongate workpiece supports attached to the corresponding upper rail for supporting a workpiece extending across the first and second sawhorses in the notches defined in the workpiece supports.

8. The sawhorse accessory according to claim 6, wherein the means for attaching comprises an over-center latch.

9. The sawhorse accessory according to claim 6, wherein the means for attaching comprises a bolt and mating nut.

10. The sawhorse accessory according to claim 6, wherein the means for attaching comprises an elastic cord.

11. A sawhorse accessory kit, comprising:
first and second sawhorses, each of the sawhorses having an upper rail;
first and second elongate workpiece supports, each of the workpiece supports being adapted for removable installation atop the upper rail of a respective one of the sawhorses, each of the workpiece supports having an upper surface having a plurality of transverse workpiece-holding notches defined therein, each of the notches forming a ninety degree included angle; and
means for attaching the workpiece supports atop the sawhorse rails.

12. The sawhorse accessory kit according to claim 11, wherein the means for attaching comprises at least one over-center latch.

13. The sawhorse accessory according to claim 11, wherein the means for attaching comprises at least one bolt and mating nut.

14. The sawhorse accessory according to claim 11, wherein the means for attaching comprises at least one elastic cord.
